(19) United States
(12) Patent Application Publication
(10) Pub. No.: US 2026/0207023 A1
(43) Pub. Date: Jul. 23, 2026

(54) Autonomous Cleaning Robot Equipped With A Wet Cleaning Device

(71) Applicant: SEB S.A., Ecully (FR)

(72) Inventors: Laurent Delair, Ecully Cedex (FR); Guillaume Denis, Ecully Cedex (FR); Mickael Boillet, Ecully Cedex (FR)

(73) Assignee: SEB S.A., Ecully (FR)

(21) Appl. No.: 19/140,817

(22) PCT Filed: Dec. 14, 2023
(86) PCT No.: PCT/FR2023/052009

§ 371 Date: Jun. 18, 2025

(30) Foreign Application Priority Data
Dec. 21, 2022 (FR) 22/14098

(51) Int. Cl. A47L 11/30; A46B 13/00; A46B 13/02; A47L 11/40; H01M 50/213; H01M 50/249

(52) U.S. Cl. CPC A47L 11/30; A46B 13/001; A46B 13/02; A47L 11/4005; A47L 11/4016; A47L 11/4041; A47L 11/4044; A47L 11/4072; H01M 50/213; H01M 50/249; A46B 2200/3033; H01M 2220/20

(57) ABSTRACT

The autonomous cleaning robot includes a main body (3); a suction unit (14) comprising a suction motor (15); a wet cleaning device located in a rear part (3.2) of the main body (3); a power battery (21); and two drive wheels (11). The suction unit (14) and the power battery (21) are arranged on either side of the median longitudinal plane (P1) of the main body (3) and in the rear part of the main body (3). A first axis (B1) passing through the center of gravity (G1) of the power battery (21) and the geometric center (C) of the main body (3) is inclined relative to the median longitudinal plane (P1) by a first angle of inclination (α1), and a second axis (B2) passing through the center of gravity (G2) of the suction unit (14) and the geometric center (C) of the main body (3) is inclined relative to the median longitudinal plane (P1) by a second angle of inclination (α2).

### TECHNICAL FIELD

The present invention relates to the field of robot vacuum cleaners capable of being autonomously displaced over a surface to be cleaned and capable of sucking up dust and debris present on the surface to be cleaned, which may, for example, be tiles, parquet, laminate, carpet, or a rug, and possibly washing the surface to be cleaned simultaneously with a vacuuming operation.

### STATE OF THE ART

The autonomous cleaning robots have become commonplace today, allowing thereof to clean entire surfaces of a home without any user assistance as long as these surfaces are flat, that is to say on the same level. They thus offer users considerable time savings, allowing them to perform other activities.

An autonomous cleaning robot comprises, in a known manner:
a main body including a lower face configured to be oriented toward a surface to be cleaned and a suction mouth opening into the lower face of the main body, the main body delimiting a suction chamber fluidly connected to the suction mouth,
two drive wheels configured to roll on the surface to be cleaned and movably mounted in rotation on the main body respectively about two axes of rotation that are substantially parallel,
a rotating cleaning brush housed in the suction chamber and movably mounted in rotation about a brush rotation axis,
a suction unit that is housed at least partially in the main body and that is configured to generate an air flow through the suction mouth,
a waste collection device comprising a waste collection container located upstream of the suction unit and configured to be traversed by the air flow generated by the suction unit and to retain waste transported by the air flow,
a wet cleaning device located in a rear part of the main body, and
a power battery configured to electrically power the autonomous cleaning robot.

The bearing force exerted on the floor to be cleaned by the wet cleaning device of such an autonomous cleaning robot may prove insufficient to ensure effective cleaning, particularly when a significant part of the mass of the autonomous cleaning robot is directly absorbed by the drive wheels.

To overcome such a drawback, it could be considered to arrange some of the heavy components of the autonomous cleaning robot in a rear part of the main body, so as to increase the bearing force exerted by the wet cleaning device on the surface to be cleaned.

Nonetheless, such a configuration of the autonomous cleaning robot is likely to cause an imbalance in the distribution of mass within the wet cleaning robot, which is likely to impair the guidance of the wet cleaning robot during its movements and also to cause uneven cleaning quality on either side of the median longitudinal plane of the main body.

### SUMMARY OF THE INVENTION

The present invention aims to overcome these drawbacks.

The technical problem underlying the invention is to provide an autonomous cleaning robot that is simple, economical, and compact, while also delivering high cleaning performance.

To this end, the invention relates to an autonomous cleaning robot comprising:
a main body including a lower face configured to be oriented toward a surface to be cleaned and a suction mouth opening into the lower face of the main body, the main body delimiting a suction chamber fluidly connected to the suction mouth,
a suction unit housed at least partially in the main body, the suction unit comprising a suction motor having a motor axis and a fan coupled to the suction motor and configured to generate an air flow through the suction mouth,
a waste collection device comprising a waste collection container located upstream of the suction unit and configured to be traversed by the air flow generated by the suction unit and to retain waste transported by the air flow,
a wet cleaning device located in a rear part of the main body,
a power battery configured to electrically power the autonomous cleaning robot,
two drive wheels configured to roll over the surface to be cleaned and movably mounted in rotation on the main body respectively about two axes of rotation that are substantially parallel.

The suction unit and the power battery are arranged on either side of a median longitudinal plane of the main body and are located in the rear part of the main body, a first axis passing through the center of gravity of the power battery and a geometric center of the main body, which is substantially located in the median longitudinal plane of the main body, is inclined relative to the median longitudinal plane of the main body by a first angle of inclination, and a second axis passing through the center of gravity of the suction unit and the geometric center of the main body is inclined relative to the median longitudinal plane of the main body by a second angle of inclination, the first and second axes defining a separation angle of less than 130°, advantageously comprised between 40° and 110°, and for example between 90° and 110°.

Such an arrangement of the suction unit and the power battery, namely on either side of the median longitudinal plane of the main body and with such a separation angle, allows for better mass distribution of the autonomous cleaning robot and thus balances the bearing forces exerted by the wet cleaning device on the surface to be cleaned.

Furthermore, the fact that the suction unit and the power battery are arranged in a rear part of the main body allows the vacuum cleaner's center of gravity to be moved back, and thus increasing the friction of the wet cleaning device on the surface to be cleaned.

Thus, the specific arrangement of the suction unit and the power battery provides improved cleaning performance for the autonomous cleaning robot.

The autonomous cleaning robot of the present invention is designed, like most autonomous cleaning robots, to effectively clean floors when it moves in a displacement direction parallel to the longitudinal axis of the autonomous cleaning robot and in a predetermined displacement direction. The displacement direction parallel to the longitudinal axis of the autonomous cleaning robot and the predetermined displacement direction define a main displacement direction of the autonomous cleaning robot of the present invention. Thus, a front part or a rear part of the main body of the autonomous cleaning robot is identified relative to the main displacement direction of the autonomous cleaning robot.

The autonomous cleaning robot may further have one or more of the following features, taken alone or in combination.

According to one embodiment of the invention, the center of gravity of an assembly formed by the suction unit and the power battery is substantially located on the median longitudinal plane of the main body. Such an arrangement of the suction unit and the power battery contributes to a better distribution of weight within the autonomous cleaning robot, which, on the one hand, ensures better balancing of the bearing forces exerted by the wet cleaning device on the surface to be cleaned and, on the other hand, ensures better guidance of the autonomous cleaning robot during its movements.

In this document, «substantially located on» means «located on» or «located at a distance of less than 1 cm from».

According to one embodiment of the invention, each of the first and second angles of inclination is comprised between 20 and 55°. Such an arrangement of the suction unit and the power battery also contributes to a better weight distribution of the autonomous cleaning robot.

According to one embodiment of the invention, an absolute value of the difference between the first and second angles of inclination is less than or equal to 10°, and for example less than or equal to 5°.

According to one embodiment of the invention, the second angle of inclination is substantially equal to the first angle of inclination.

According to one embodiment of the invention, the geometric center of the main body is arranged between the drive wheels.

According to one embodiment of the invention, the geometric center of the main body is substantially located at the intersection of the median longitudinal plane of the main body and a vertical plane containing the axes of rotation of the drive wheels.

According to one embodiment of the invention, the suction unit and the power battery are arranged substantially symmetrically with respect to the median longitudinal plane of the main body.

According to one embodiment of the invention, the second axis is contained in a median vertical plane of the power battery.

According to one embodiment of the invention, the second axis is contained in a vertical plane containing the motor axis of the suction motor.

According to one embodiment of the invention, the suction unit and the power battery are located behind the rotation axes of the two drive wheels, and for example, mostly behind the two drive wheels. Such an arrangement of the suction unit and the power battery increases the friction of the wet cleaning device on the surface to be cleaned, due to the weight exerted by the main body on the wet cleaning device. Thus, such an arrangement of the suction unit and the power battery increases the scraping efficiency of the wet cleaning device on the floor and therefore the cleaning quality of the autonomous cleaning robot.

According to one embodiment of the invention, the wet cleaning device includes two mop holders, each mounted on the main body, and two mops removably mounted respectively on the two mop holders and configured to be in contact with the surface to be cleaned, the power supply battery being located at least partially above one of the mop holders and the suction unit being located at least partially above the other of the mop holders. Such an arrangement of the suction unit and the power supply battery further increases the friction of the wet cleaning device on the surface to be cleaned, and thus further improves the cleaning quality of the autonomous cleaning robot.

According to one embodiment of the invention, the autonomous cleaning robot is configured such that, when the autonomous cleaning robot rests on a surface to be cleaned, a rear part of the autonomous cleaning robot rests directly on said surface to be cleaned by the two mops. Such a configuration of the autonomous cleaning robot allows the mops to directly absorb at least part of the mass of the autonomous cleaning robot, and thus further increase the bearing force exerted by each of the mops on the floor to be cleaned. Thus, such a configuration of the autonomous cleaning robot further improves the cleaning quality of the autonomous cleaning robot.

According to one embodiment of the invention, the center of gravity of the power battery is located above one of the mop holders, and the center of gravity of the suction unit is located above the other of the mop holders.

According to one embodiment of the invention, the power supply battery is located entirely above one of the mop holders, and the suction unit is located entirely above the other of the mop holders.

According to one embodiment of the invention, the autonomous cleaning robot includes a cleaning liquid tank. Advantageously, the cleaning liquid tank is arranged between the drive wheels. Thus, changes in the filling level of the cleaning liquid tank are unlikely to unbalance the weight distribution within the wet cleaning robot.

According to one embodiment of the invention, the wet cleaning device includes at least one liquid outlet orifice configured to be fluidically connected to the cleaning liquid tank and configured to supply cleaning liquid to the mops mounted on the mop holders.

According to one embodiment of the invention, the waste collection container is located at least partially between the drive wheels.

According to one embodiment of the invention, the power battery includes battery cells that are generally cylindrical in shape and that have cell axes that are substantially parallel to each other.

According to one embodiment of the invention, the median vertical plane of the power battery extends substantially perpendicular to the cell axes of the battery cells.

According to another embodiment of the invention, the median vertical plane of the power battery extends substantially parallel to the cell axes of the battery cells.

According to one embodiment of the invention, the autonomous cleaning robot includes a connecting channel fluidically connecting the suction chamber to the waste collection container.

According to one embodiment of the invention, the connecting channel has a generally cylindrical shape and is configured to extend substantially vertically when the autonomous cleaning robot is resting on a horizontal surface.

According to one embodiment of the invention, the connecting channel has a circular or oblong cross-section.

According to one embodiment of the invention, the connecting channel opens into a rear part of the suction chamber. Such an arrangement of the connecting channel further facilitates the guidance of the vacuumed waste toward the waste collection container.

According to one embodiment of the invention, the median longitudinal plane of the main body intersects with the connecting channel.

According to one embodiment of the invention, the main body includes a rear edge that is curved and, when viewed from above in a substantially vertical orientation, has the shape of an arc of a circle. Advantageously, the rear edge has a radius of curvature whose center corresponds to the geometric center of the main body.

According to one embodiment of the invention, the main body has, when viewed from above in a substantially vertical orientation, a general D-shape.

According to one embodiment of the invention, the waste collection device is removably mounted on the main body.

According to one embodiment of the invention, the suction mouth is provided in a front part of the main body.

According to one embodiment of the invention, the autonomous cleaning robot includes a rotating cleaning brush housed in the suction chamber and movably mounted in rotation about a brush rotation axis.

According to one embodiment of the invention, the brush rotation axis extends transversely, and for example perpendicularly, to the main displacement direction of the autonomous cleaning robot.

According to one embodiment of the invention, the suction mouth has an elongated shape and extends in a direction of extension that is transverse, and for example perpendicular, to the main displacement direction of the autonomous cleaning robot.

### BRIEF DESCRIPTION OF THE FIGURES

The aims, aspects, and advantages of the present invention will be better understood from the following description of an embodiment of the invention presented by way of non-limiting example, with reference to the accompanying drawings, in which:

FIG. 1 is a top perspective view of an autonomous cleaning robot according to the invention.

FIG. 2 is a bottom perspective view of the autonomous cleaning robot of FIG. 1.

FIG. 3 is a partial bottom perspective view of the autonomous cleaning robot of FIG. 1.

FIG. 4 is a bottom view of the autonomous cleaning robot of FIG. 1.

FIG. 5 is a side view of the autonomous cleaning robot of FIG. 1.

FIG. 6 is a longitudinal sectional view of the autonomous cleaning robot of FIG. 1.

FIG. 7 is a top view of the autonomous cleaning robot of FIG. 1.

FIG. 8 is a partial top view of the autonomous cleaning robot of FIG. 1.

FIG. 9 is a top perspective view of the autonomous cleaning robot of FIG. 1, showing the wet cleaning device removed from the main body.

### DETAILED DESCRIPTION

Only the elements necessary for understanding the invention are shown. To facilitate reading the drawings, the same elements bear the same references from one figure to the other.

It should be noted that in this document, the terms «horizontal», «vertical», «lower», «upper», «top», and «below» used to describe the autonomous cleaning robot or the main body refer to the autonomous cleaning robot in use when it rests by its wheels on a floor to be cleaned that is flat and horizontal.

In this document, the term «median longitudinal plane» means a vertical plane parallel to the main displacement direction and dividing the main body into two substantially equal parts.

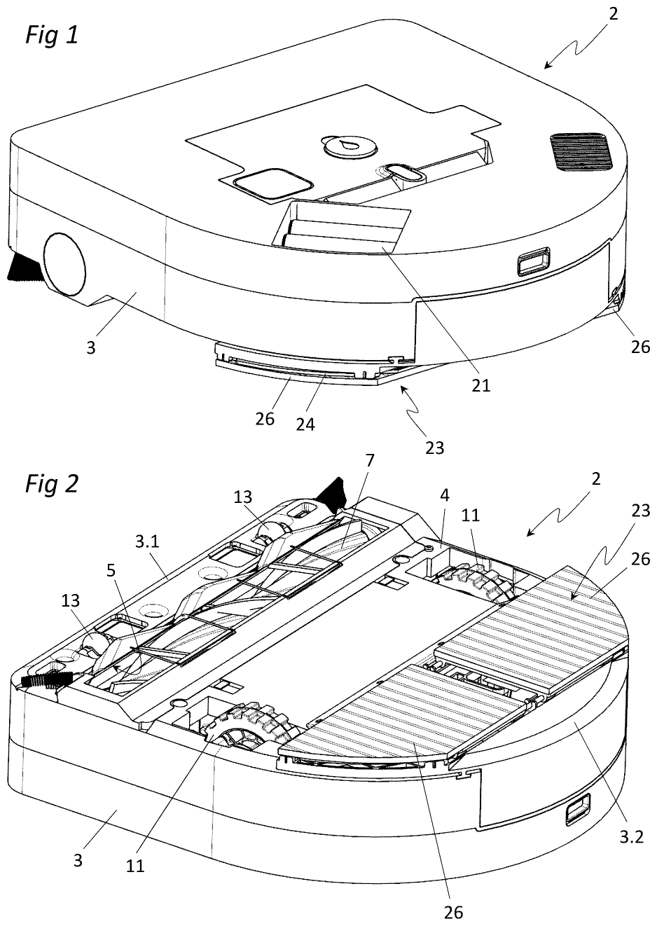

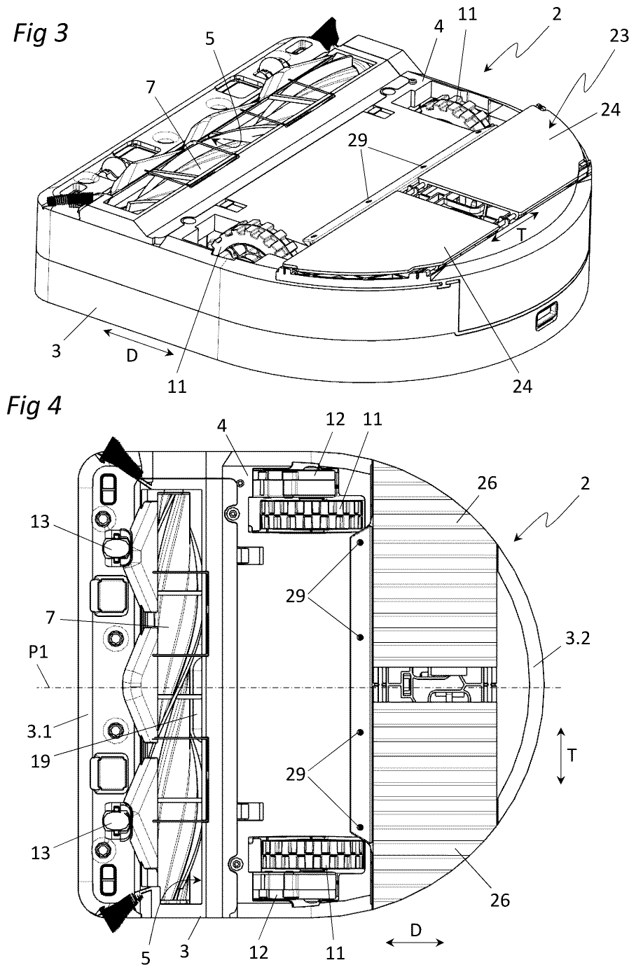

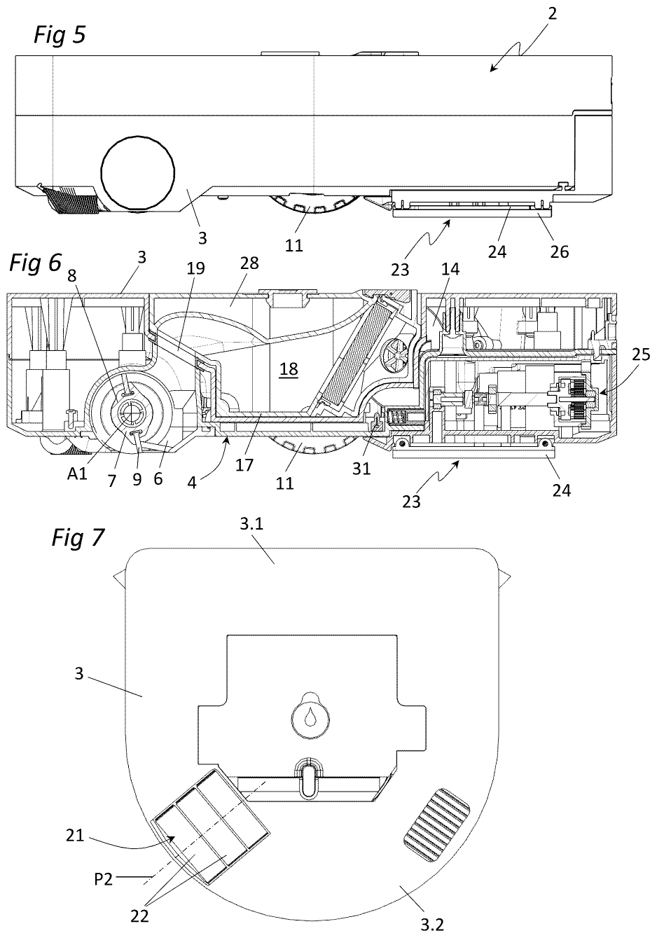

FIGS. 1 to 9 show an autonomous cleaning robot 2, and more particularly a robot vacuum cleaner, configured to be displaced autonomously over a surface to be cleaned.

The autonomous cleaning robot 2 comprises a main body 3 including a lower face 4 that is configured to be oriented toward the surface to be cleaned, and a suction mouth 5 that is provided in a front part 3.1 of the main body 3 and that opens into the lower face 4 of the main body 3. Advantageously, the suction mouth 5 is elongated and extends in an extension direction that is perpendicular to a main displacement direction D of the autonomous cleaning robot 2.

As shown in FIG. 6, the main body 3 delimits a suction chamber 6 that opens into the lower face 4 of the main body 3 via the suction mouth 5.

According to the embodiment shown in the figures, the main body 3 has, when viewed from above in a substantially vertical orientation, a general D shape, and includes a rear edge that is curved and, when viewed from above in a substantially vertical orientation, has the shape of an arc of a circle. However, the main body 3 could have a completely different shape, for example a generally circular or rectangular shape. Advantageously, the rear edge of the main body 3 has a radius of curvature whose center corresponds to the geometric center C of the main body 3.

The autonomous cleaning robot 2 further comprises a rotating cleaning brush 7 housed in the suction chamber 6 and movably mounted in rotation about a brush rotation axis A1 that extends transversely, and more particularly perpendicularly, to the main displacement direction D. Advantageously, the brush rotation axis A1 is substantially horizontal when the autonomous cleaning robot 2 is resting on a horizontal surface.

According to the embodiment shown in the figures, the rotating cleaning brush 7 includes a brush body 8 that has a central longitudinal axis and is configured to be rotated in a predetermined direction of rotation and about the brush rotation axis A1. Advantageously, the brush rotation axis A is coaxial with the central longitudinal axis of the brush body 8.

The rotating cleaning brush 7 further includes one or more rows of bristles 9, for example two rows of bristles, provided on an outer peripheral surface of the brush body 8 and extending over at least a part of the length of the brush body 8. According to a variant of the invention, the rotating cleaning brush 7 could further include, or instead of the rows of bristles 9, one or more cleaning strips, for example elastically deformable or rigid, provided on the outer peripheral surface of the brush body 8.

The autonomous cleaning robot 2 also comprises a drive mechanism (not visible in the figures) which is configured to rotatably drive the brush body 8 about the brush rotation axis A1.

As shown more particularly in the FIGS. 2 to 4, the autonomous cleaning robot 2 comprises two drive wheels 11 which are configured to roll over the surface to be cleaned. The two drive wheels 11 are movably mounted in rotation relative to the main body 3 and have axes of rotation that are parallel, and advantageously coaxial. Advantageously, the axes of rotation of the drive wheels 11 extend perpendicular to the main displacement direction D.

The two drive wheels 11 are configured to protrude from the lower face 4 of the main body 3 and are arranged on either side of a median longitudinal plane P1 of the main body 3. Advantageously, the two drive wheels 11 are arranged symmetrically relative to the median longitudinal plane P1 of the main body 3 and are lateral wheels of the autonomous cleaning robot 2.

The two drive wheels 11 are advantageously motorized independently of one another. Thus, the autonomous cleaning robot 2 comprises two rotational drive mechanisms 12 housed in the main body 3 and each configured to rotatably drive a respective drive wheel 11 among the two drive wheels 11. Each rotational drive mechanism 12 includes a drive motor coupled in rotation to the respective drive wheel 11 and arranged, for example, in a respective lateral part of the main body 3. Depending on the control of the two aforementioned drive motors, the main body 3 can pivot left, right, or on itself, and move forward or backward.

According to the embodiment shown in the figures, the autonomous cleaning robot 2 includes additional wheels 13 freely mounted in rotation relative to the main body 3, and for example two additional wheels 13 arranged on the front part 3.1 of the main body 3. Advantageously, all the additional wheels 13 are located in front of the rotation axes of the two drive wheels 11, such that the autonomous cleaning robot 2 is without an additional wheel located behind the rotation axes of the two drive wheels 11.

The autonomous cleaning robot 2 further comprises a suction unit 14 housed in the main body 3. The suction unit 14 comprises a suction motor 15 having a motor axis and a fan 16 coupled to the suction motor 15 and configured to generate an air flow through the suction mouth. 5.

The autonomous cleaning robot 2 also comprises a waste collection device 17 (see FIG. 6) removably mounted on the main body 3. The waste collection device 17 includes a waste collection container 18 located upstream of the suction unit 14 and at least partially between the drive wheels 11. The waste collection container 18 is configured to be traversed by the air flow generated by the fan 16 when the autonomous cleaning robot 2 is in operation, and to retain waste transported by the air flow.

The autonomous cleaning robot 2 further comprises a connecting channel 19 fluidically connecting the suction chamber 6 to the waste collection container 18. The connecting channel 19 has a generally cylindrical shape and is configured to extend vertically when the autonomous cleaning robot 2 rests on a horizontal surface. However, the connecting channel 19 could be configured to be inclined relative to the vertical by an angle of inclination less than or equal to 10°, and for example less than or equal to 5°, when the autonomous cleaning robot 2 rests on a horizontal surface. The connecting channel 19 may, for example, have an oblong or circular cross-section.

As shown in FIGS. 4 and 6, the connecting channel 19 opens into a rear part of the suction chamber 6, and the median longitudinal plane P1 of the main body 3 intersects the connecting channel 19.

The autonomous cleaning robot 2 also includes a power battery 21 configured to electrically power the autonomous cleaning robot 2. The power battery 21 is rechargeable and is housed in the main body 3.

The power battery 21 includes battery cells 22 that are generally cylindrical in shape and have cell axes that are substantially parallel to each other. According to the embodiment shown in the figures, the power battery 21 has a median vertical plane P2 which extends substantially perpendicular to the cell axes of the battery cells 22. However, according to a variant of the invention, the battery cells 22 could have an orientation rotated by 90° relative to the orientation shown in FIG. 7, such that the median vertical plane P2 of the power battery 21 extends substantially parallel to the cell axes of the battery cells 22.

The suction unit 14 and the power battery 21 are arranged on either side of the median longitudinal plane P1 of the main body 3 and are located in a rear part 3.2 of the main body 3, and preferably behind the axes of rotation of the two drive wheels 11. Advantageously, the suction unit 14 and the power battery 21 are arranged substantially symmetrically with respect to the median longitudinal plane P1 of the main body 3.

According to one embodiment of the invention, the center of gravity G of an assembly formed by the suction unit 14 and the power battery 21 is substantially located on the median longitudinal plane P1 of the main body 3.

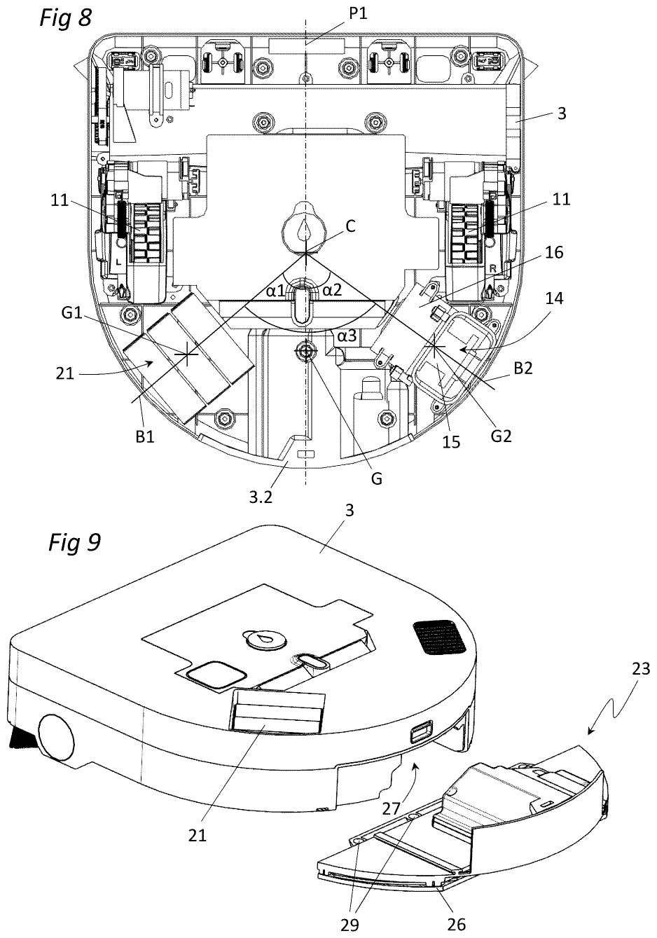

As shown in FIG. 8, a first axis B1 passing through the center of gravity G1 of the power battery 21 and the geometric center C of the main body 3, which is located in the median longitudinal plane P1 of the main body 3, is inclined relative to the median longitudinal plane P1 of the main body 3 by a first angle of inclination α1, and a second axis B2 passing through the center of gravity G2 of the suction unit 14 and the geometric center C of the main body 3 is inclined relative to the median longitudinal plane P1 of the main body 3 by a second angle of inclination α2. An absolute value of the difference between the first and second angles of inclination α1, α2 is less than or equal to 10°, and for example less than or equal to 5°. Advantageously, the second angle of inclination α2 is substantially equal to the first angle of inclination α1.

According to the embodiment shown in the figures, the first and second axes B1, B2 define a separation angle a 3 less than 130°, and advantageously comprised between 40° and 110°, and for example between 90° and 110°, and each of the first and second angles of inclination α1, α2 is comprised between 20 and 55°. Advantageously, the median vertical plane P2 of the power battery 21 contains the first axis B1, and the second axis B2 is contained in a vertical plane containing the motor axis of the suction motor 15.

As shown in FIG. 8, the geometric center C of the main body 3 is substantially located at the intersection of the median longitudinal plane P1 of the main body 3 and a vertical plane containing the axes of rotation of the drive wheels 11.

As shown in particular in FIG. 2, the autonomous cleaning robot 2 further comprises a wet cleaning device 23 which is arranged in the rear part 3.2 of the main body 3. Advantageously, the wet cleaning device 23 is arranged opposite the rotating cleaning brush 7 with respect to the axes of rotation of the drive wheels 11.

According to the embodiment shown in the figures, the wet cleaning device 23 includes two mop holders 24 which are arranged side by side and which are located behind the rotation axes of the drive wheels 11. Advantageously, the two mop holders 24 are arranged on either side of the median longitudinal plane P1 of the main body 3, and are configured to extend substantially horizontally when the main body 3 rests on a horizontal surface.

Advantageously, the power battery 21 is located at least partially, and for example entirely, above one of the mop holders 24, and the suction unit 14 is located at least partially, and for example entirely, above the other of the mop holders 24. Thus, the center of gravity G1 of the power battery 21 is located above one of the mop holders 24, and the center of gravity G2 of the suction unit 14 is located above the other of the mop holders 24.

According to the embodiment shown in the figures, the two mop holders 24 are each movably mounted in translation relative to the main body 3 in a translation direction T which extends transversely, and advantageously perpendicularly, to the main displacement direction D of the autonomous cleaning robot 2. Advantageously, the mop holders 24 are movably mounted relative to each other between a close configuration in which the two mop holders 24 are brought together, and a distant configuration in which the two mop holders 24 are distant from each other.

The wet cleaning device 23 also includes a translational drive mechanism 25 configured to displace in translation the mop holders 24 along the translation direction T and alternately between the close configuration and the distant configuration.

The wet cleaning device 23 further includes two mops 26 removably mounted respectively on the two mop holders 24. The mops 26 are configured to be in contact with the surface to be cleaned, and more particularly to exert a bearing force on the surface to be cleaned, when the autonomous cleaning robot 2 rests on the surface to be cleaned.

Advantageously, the autonomous cleaning robot 2 is configured such that, when the autonomous cleaning robot 2 rests on a surface to be cleaned, a rear part of the autonomous cleaning robot 2 rests on said surface to be cleaned directly by the two mops 26.

As shown more particularly in FIG. 9, the wet cleaning device 23 is removably mounted relative to the main body 3, and the main body 3 includes a receiving housing 27 in which the wet cleaning device 23 is at least partially received. The wet cleaning device 23 is advantageously configured to be removed from the main body 3 by a translational movement directed towards the rear of the main body 3.

The autonomous cleaning robot 2 also includes a cleaning liquid tank 28 which is mounted, for example removably, on the main body 3. The cleaning liquid tank 28 may, for example, be arranged between the drive wheels 11. The cleaning liquid tank 28 and the waste collection container 18 may, for example, be stacked on top of each other and be integral with each other. According to such an embodiment, the autonomous cleaning robot 2 may, for example, include a removable tank including a first compartment forming the cleaning liquid tank 28 and a second compartment forming the waste collection container 18. Nonetheless, according to a variant of the invention, the cleaning liquid tank 28 could be separate from the waste collection device 17, and, for example, be provided directly on the wet cleaning device 23.

The wet cleaning device 23 further includes a plurality of liquid outlet orifices 29 which are configured to be fluidically connected to the cleaning liquid tank 28 and which are configured to supply cleaning liquid to the mops 26 mounted on the mop holders 24. Advantageously, the liquid outlet orifices 29 are located at the front of the mop holders 24, and, for example, at the front of the mops 26, and are configured to be oriented toward the surface to be cleaned.

The autonomous cleaning robot 2 also includes a cleaning liquid supply circuit (not described in detail) provided on the main body 3 and configured to fluidically connect the liquid outlet orifices 29 to the cleaning liquid tank 28. The cleaning liquid supply circuit may, for example, include a dispenser 31 (see FIG. 6) housed in the main body 3.

According to a variant of the invention not shown in the figures, the wet cleaning device 23 could be provided with a floor treatment element, other than a mop, configured to perform a mechanical, chemical, thermal, or radiant treatment of the floor.

According to another variant of the invention not shown in the figures, the wet cleaning device 23 could include at least one passive mop, that is to say mounted immobile relative to the main body 3.

Of course, the invention is in no way limited to the embodiment described and illustrated, which has been given solely as an example. Modifications remain possible, particularly with regard to the composition of the various elements or by substituting technical equivalents, without departing from the scope of the invention.

1. An autonomous cleaning robot comprising:
a main body having a lower face configured to be oriented toward a surface to be cleaned and a suction mouth opening into the lower face of the main body, the main body delimiting a suction chamber fluidly connected to the suction mouth,
a suction unit which is housed at least partially in the main body, the suction unit comprising a suction motor having a motor axis and a fan which is coupled to the suction motor and which is configured to generate an air flow through the suction mouth,
a waste collection device comprising a waste collection container located upstream of the suction unit and configured to be traversed by the air flow generated by the suction unit and to retain waste transported by the air flow,
a wet cleaning device located in a rear part of the main body,
a power battery configured to electrically power the autonomous cleaning robot, and
two drive wheels configured to roll on the surface to be cleaned and movably mounted in rotation on the main body respectively about two axes of rotation which are substantially parallel,
characterized in that the suction unit and the power battery are arranged on either side of a median longitudinal plane of the main body and are located in the rear part of the main body, in that a first axis passing through the center of gravity of the power battery and a geometric center of the main body, which is substantially located in the median longitudinal plane of the main body, is inclined relative to the median longitudinal plane of the main body by a first angle of inclination and in that a second axis passing through the center of gravity of the suction unit and the geometric center of the main body is inclined relative to the median longitudinal plane of the main body by a second angle of inclination the first and second axes defining a separation angle of less than 130°.

2. The autonomous cleaning robot according to claim 1, wherein the center of gravity of an assembly formed by the suction unit and the power battery is substantially located on the median longitudinal plane of the main body.

3. The autonomous cleaning robot according to claim 1, wherein each of the first and second angles of inclination is comprised between 20° and 55°.

4. The autonomous cleaning robot according to claim 1, wherein an absolute value of the difference between the first and second angles of inclination is less than or equal to 10°.

5. The autonomous cleaning robot according to claim 1, wherein the geometric center of the main body is substantially located at an intersection of the median longitudinal plane of the main body and a vertical plane containing the rotation axes of the drive wheels.

6. The autonomous cleaning robot according to claim 1, wherein the suction unit and the power battery are arranged substantially symmetrically with respect to the median longitudinal plane of the main body.

7. The autonomous cleaning robot according to claim 1, wherein the first axis is contained in a median vertical plane of the power battery.

8. The autonomous cleaning robot according to claim 1, wherein the second axis is contained in a vertical plane containing the motor axis of the suction motor.

9. The autonomous cleaning robot according to claim 1, wherein the suction unit and the power battery are located behind the rotation axes of the two drive wheels.

10. The autonomous cleaning robot according to claim 1, wherein the wet cleaning device comprises two mop holders each mounted on the main body, and two mops removably mounted respectively on the two mop holders and configured to be in contact with the surface to be cleaned, the power battery being located at least partially above one of the mop holders and the suction unit being located at least partially above the other of the mop holders.

11. The autonomous cleaning robot according to claim 1, wherein the power battery comprises battery cells that are generally cylindrical in shape and have cell axes that are substantially parallel to each other.

12. The autonomous cleaning robot according to claim 11, wherein the median vertical plane of the power battery extends substantially perpendicular to the cell axes of the battery cells.

13. The autonomous cleaning robot according to claim 1, which comprises a rotating cleaning brush housed in the suction chamber and movably mounted in rotation about a brush rotation axis.
